(19) United States
(12) Patent Application Publication
(10) Pub. No.: US 2009/0249798 A1
(43) Pub. Date: Oct. 8, 2009

(54) APPARATUS AND METHOD FOR INCREASING EFFICIENCY OF A GAS TURBINE AND A MARINE STRUCTURE HAVING THE SAME

(75) Inventors: Jung Han Lee, Geoje-si (KR); Dong Kyu Choi, Geoje-si (KR); Young Soo Kim, Geoje-si (KR)

Correspondence Address: SEED INTELLECTUAL PROPERTY LAW GROUP PLLC, 701 FIFTH AVE, SUITE 5400, SEATTLE, WA, 98104, US

(73) Assignee: DAEWOO SHIPBUILDING & MARINE ENGINEERING CO., LTD., Seoul (KR)

(21) Appl. No.: 12/175,194

(22) Filed: Jul. 17, 2008

(30) Foreign Application Priority Data
Apr. 7, 2008 (KR) 10-2008-0031956

(51) Int. Cl. F17C 9/02

(52) U.S. Cl. 62/50.2; 290/40 B

(57) ABSTRACT

An apparatus and method for increasing efficiency of a gas turbine and a marine structure having the gas turbine are disclosed. The marine structure includes an ambient LNG vaporizer for regasifying cryogenic LNG via heat exchange with air and the gas turbine for generating electric power. The marine structure includes a moist-air mixing chamber disposed at an upstream side of the gas turbine, a condensed-water nozzle to spray condensed water, generated from air during the heat exchange in the LNG vaporizer, into the moist-air mixing chamber; and a cold air supply pipe to supply air, cooled by the heat exchange in the LNG vaporizer, to the gas turbine via the moist-air mixing chamber. The method reduces the temperature of air supplied to the gas turbine by condensed water or cold air generated during regasification of LNG through the ambient vaporizer in the marine structure, thereby increasing the efficiency of the gas turbine.

### BACKGROUND

1. Technical Field

The present disclosure generally relates to systems with gas turbines, and more particularly, to an apparatus and a method for increasing efficiency of a gas turbine. The present invention also relates to a marine structure having the gas turbine.

2. Description of the Related Art

In recent years, the use of natural gas has rapidly expanded throughout the world. Natural gas is transported long distances in a gaseous state through a gas pipe line over land or sea, or is transported in a liquid state by liquefied natural gas (LNG) carriers. LNG is obtained by cooling natural gas into a cryogenic state (about −163° C.) where the volume of the natural gas is reduced to about 1/600 that at standard temperature and pressure, which makes it eminently suitable for long distance marine transportation.

The LNG carrier is provided for shipping and discharging the LNG when carrying it to a land destination by sea. For this purpose, the LNG carrier includes an LNG storage tank (e.g., a cargo tank) capable of withstanding the cryogenic state of the LNG. Typically, the LNG carrier discharges the LNG from the LNG storage tank at a destination in the liquefied state, and the discharged LNG is regasified by LNG regasification equipment installed at the destination and is then supplied to natural gas consumers through the gas pipe line.

The land-based LNG regasification equipment is economically advantageous in the case where the equipment is installed in such a place where natural gas markets are actively and stably established to satisfy demand for natural gas. However, the land-based LNG regasification equipment is economically disadvantageous in the case where the equipment is installed in such a place where a market for natural gas is seasonal, short-term or periodic, since installation and maintenance of the LNG regasification equipment is relatively expensive.

In particular, if the LNG regasification equipment is destroyed by natural disasters or the like, even though the LNG carrier arrives at the destination to discharge the LNG, it is impossible to regasify the LNG. Therefore, there is a limit in transportation of the natural gas through the conventional LNG carrier.

Accordingly, there has been developed a marine LNG regasification system wherein LNG regasification equipment is installed in the LNG carrier or a marine structure to regasify the LNG at sea and supply natural gas obtained by the regasification to the land.

Examples of the marine structure with the LNG regasification equipment include an LNG RV (regasification vessel), an LNG FSRU (floating storage and regasification unit), etc. Additionally, an LNG FPSO (floating, production, storage and off-loading) or a similar marine structure may have the LNG regasification equipment.

The LNG RV is a floating LNG carrier that has LNG regasification equipment and is seafaring. The LNG FSRU is a floating marine structure that can store LNG, unloaded from an LNG carrier, in a cargo tank at sea a long distance from the land to gasify the LNG as needed, thereby supplying the regasified LNG to consumers on the land. The LNG FPSO is a floating marine structure that directly liquefies natural gas into LNG at sea and stores the LNG in an LNG cargo tank thereof to deliver the LNG stored in the LNG cargo tank to another LNG carrier as needed.

In such marine structures, a gas turbine is used for generating electric power. The lower the temperature of combustion air supplied to the gas turbine, the higher the efficiency of the gas turbine.

An evaporative cooling method has been proposed to lower the temperature of the combustion air to increase the efficiency of the gas turbine. In this method, water is forced to flow together with air into or is sprayed into the gas turbine, so that air can be cooled during evaporation of water. Such evaporative cooling methods are disclosed in U.S. Pat. No. 5,390,505, Japanese Patent Laid-open Publication No. H08-151933, etc.

However, since the conventional method employs only latent heat resulting from evaporation of water to cool air, there is a limit to lower the temperature of air below a saturated temperature of moist air. Particularly, under the condition that the atmospheric temperature is low (e.g., in winter or at high latitudes), such a conventional method has problems in that efficiency of the gas turbine can be decreased and output thereof can become unstable depending on the atmospheric temperature.

### BRIEF SUMMARY

According to one embodiment, an apparatus and a method for increasing efficiency of a gas turbine are provided. This apparatus is configured to lower a temperature of air supplied to the gas turbine using condensed water or cold air generated during regasification of LNG through an ambient vaporizer in a marine structure including LNG regasification equipment. According to another embodiment, a marine structure having the gas turbine is provided.

In accordance with one embodiment, a marine structure with an ambient liquefied natural gas (LNG) vaporizer for regasifying LNG in a cryogenic state via heat exchange with air and a gas turbine for generating electric power or driving power is provided, the marine structure including: a moist-air mixing chamber disposed toward an upstream side of the gas turbine; a condensed-water nozzle to spray condensed water, condensed from air during the heat exchange in the ambient LNG vaporizer, into the moisture-air mixing chamber; and a cold air supply pipe to supply air, cooled by the heat exchange in the ambient LNG vaporizer, to the gas turbine via the moisture-air mixing chamber.

In accordance with another embodiment, a marine structure with an ambient LNG vaporizer for regasifying LNG in a cryogenic state via heat exchange with air and a gas turbine for generating electric power or driving power is provided, including: a condensed-water mixing mechanism to cool air for combustion by mixing condensed water, condensed from air during the heat exchange in the ambient LNG vaporizer, with the air for combustion to be supplied to the gas turbine.

The condensed-water mixing mechanism may comprise a nozzle to spray the condensed water in the form of minute water particles into the air for combustion to be supplied to the gas turbine.

According to one aspect, the marine structure may further include a moist-air mixing chamber including the condensed-water mixing mechanism therein and disposed at an upstream side of the gas turbine to mix the air for combustion with the condensed water condensed in the ambient LNG vaporizer.

According to another aspect, the marine structure may further include a cold air supply pipe to supply cold air as the air for combustion to the gas turbine, the cold air being generated by cooling the air with a cold source from the LNG via the heat exchange in the ambient LNG vaporizer. The cold source is also referred to as cold heat in at least some applications in the relevant field, and can include absorbing energy and producing a cooling effect.

According to yet another aspect, the marine structure may further include a moist-air mixing chamber including the condensed-water mixing mechanism therein and disposed at an upstream side of the gas turbine to mix the cold air cooled in the ambient LNG vaporizer with the condensed water condensed in the ambient LNG vaporizer.

According to one aspect, the marine structure may further include a condensed-water storage tank to store the condensed water condensed in the ambient LNG vaporizer, and a condensed-water pump to transfer the condensed water stored in the condensed-water storage tank to the nozzle.

According to one aspect, the marine structure may further include a condensed-water adjusting valve to adjust an amount of condensed water to be transferred

In some embodiments, the cold air supply pipe may include an air adjusting damper to adjust an amount of air for combustion supplied to the gas turbine.

The LNG gasified in the ambient LNG vaporizer can be used as fuel for the gas turbine.

In some embodiments, the marine structure may be a marine floating structure having LNG regasification equipment and selected from an LNG RV (regasification vessel), an LNG FSRU (floating storage and regasification unit), or an LNG FPSO (floating, production, storage and off-loading).

In accordance with a further embodiment, a marine structure with an ambient LNG vaporizer for regasifying LNG in a cryogenic state via heat exchange with air and a gas turbine for generating electric power or driving power is provided, the marine structure including: a cold air supply pipe to supply air, cooled by a cold source from the LNG via the heat exchange in the ambient LNG vaporizer, to the gas turbine. The cold source is also referred to as cold heat in at least some applications in the relevant field, and can include absorbing energy and producing a cooling effect.

In one aspect, the marine structure may further include a condensed-water mixing mechanism to cool air for combustion by mixing condensed water, generated from air during the heat exchange in the ambient LNG vaporizer, with the air for combustion to be supplied to the gas turbine.

In accordance with yet another embodiment, a method for increasing efficiency of a gas turbine in a marine structure is provided. Here, the marine structure has an ambient LNG vaporizer for regasifying LNG in a cryogenic state via heat exchange with air and a gas turbine for generating electric power or driving power. The method includes cooling air for combustion by mixing condensed water, generated from air during the heat exchange in the ambient LNG vaporizer, with the air for combustion to be supplied to the gas turbine.

According to one aspect, the method may include heat exchanging between the LNG and the air in the ambient LNG vaporizer to regasify the LNG while cooling the air to a low temperature; mixing the condensed water, generated from the air in the heat exchanging, with the air for combustion; and supplying the air for combustion mixed with the condensed water to the gas turbine.

According to one aspect, the method may include heat exchanging between the LNG and the air in the ambient LNG vaporizer to regasify the LNG while cooling the air to a low temperature; mixing the air cooled to the low temperature via the heat exchange with the condensed water generated from the air in the heat exchanging to generate the air for combustion; and supplying the air for combustion containing the condensed water to the gas turbine.

As described above, an apparatus and a method according to embodiments of the present invention lowers the temperature of air supplied to a gas turbine using cold air or condensed water generated during regasification of LNG by an ambient vaporizer provided to a marine structure with LNG regasification equipment, thereby increasing efficiency of a gas turbine.

Further, according to embodiments of the present invention, a marine structure lowers the temperature of supplied air using cold air or the condensed water generated during regasification of LNG by an ambient vaporizer, thereby improving the efficiency of the gas turbine.

Therefore, according to embodiments of the present invention, the temperature of air supplied to the gas turbine can be stably and constantly maintained regardless of the external atmospheric temperature to thereby maintain the output of the gas turbine. Further, since the gas turbine provides a higher output than the conventional gas turbine despite having the same specifications as the conventional gas turbine, it is possible to reduce fuel consumption of the gas turbine while supplying sufficient power to the marine structure.

### BRIEF DESCRIPTION OF THE SEVERAL VIEWS OF THE DRAWINGS

The above and other objects, features and advantages will become apparent from the following description of the disclosed embodiments given in conjunction with the accompanying drawings, in which:

FIG. 1A is a schematic view illustrating a marine structure according to one embodiment;

FIG. 1B is a schematic view illustrating an apparatus and a method for increasing efficiency of a gas turbine according to one embodiment; and

FIG. 1C is a schematic view illustrating an apparatus and a method for increasing efficiency of a gas turbine according to another embodiment.

### DETAILED DESCRIPTION

Some embodiments of the present invention will be described in detail with reference to the accompanying drawings hereinafter.

Hereinafter, the term “marine structure” refers to any structure or vessel including a cargo tank configured to store liquid goods such as liquefied natural gas (LNG) in a cryogenic state, which can be used while floating at sea. Examples of the marine structure include, but are not limited to, an LNG FPSO (floating, production, storage and off-loading), an LNG FSRU (floating storage and regasification unit), an LNG RV (regasification vessel), and the like.

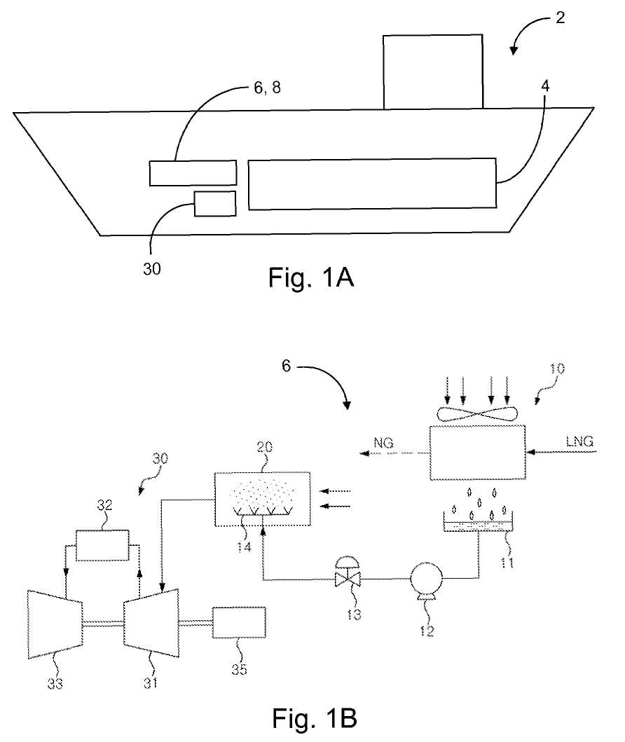

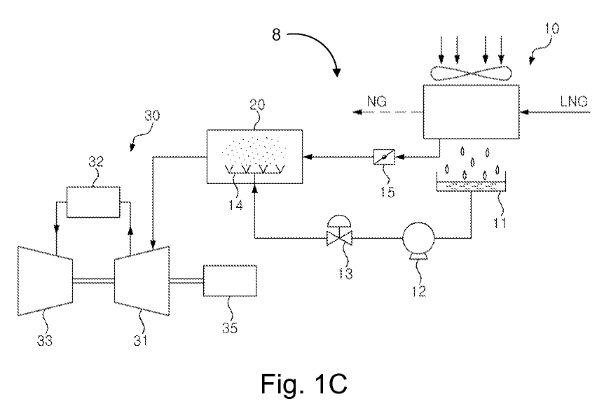

FIG. 1A illustrates a marine structure 2 including a gas turbine 30, an LNG cargo tank 4 configured to store LNG in a cryogenic state, and an apparatus 6, 8 (see FIGS. 1B and 1C) for increasing efficiency of a gas turbine, according to one embodiment. FIG. 1B is a schematic view illustrating the apparatus and a method 6 for increasing efficiency of a gas turbine according to one embodiment. As shown in FIG. 1B, the LNG is gasified by an ambient LNG vaporizer 10 as needed, and is then supplied to consumers or is supplied for use as fuel for various devices mounted on the marine structure 2, or for any other suitable purpose.

The ambient LNG vaporizer 10 regasifies the LNG via heat exchange with air. During heat exchange between the LNG and air in the ambient LNG vaporizer 10, the LNG is regasified into natural gas (NG) while air is cooled by heat transfer to the LNG. Here, since air contains vaporized water molecules, the heat exchange between air and the LNG condenses the vapor into condensed water.

Thus, condensed water generated in the ambient LNG vaporizer 10 during LNG regasification is collected in a condensed-water storage tank 11 located below the ambient LNG vaporizer 10. Condensed water collected in the condensed-water storage tank 11 is supplied by a condensed-water pump 12 to a condensed-water nozzle 14 that is disposed inside a moist-air mixing chamber 20 to act as a condensed-water mixing mechanism. The amount of condensed water supplied from the condensed-water storage tank 11 to the condensed-water nozzle 14 may be adjusted by a condensed-water adjusting valve 13.

In the moisture-air mixing chamber 20, condensed water is sprayed in the form of minute particles by the condensed-water nozzle 14 and is mixed with room temperature external air, forming moist air. Moist air obtained by spraying the minute water particles is supplied to a gas turbine 30 and is used for combustion.

As the amount of condensed water supplied to the moist-air mixing chamber 20 is adjusted by the condensed-water adjusting valve 13, it is possible to adjust the temperature and humidity of air supplied to the gas turbine 30 via the moist-air mixing chamber 20. Further, when the temperature and humidity of air are varied depending on external temperature, the temperature and humidity of air supplied to the gas turbine 30 can be stably maintained by adjusting the amount of condensed water.

Moist air prepared by mixing air with the minute water particles in the moist-air mixing chamber 20 is supplied to the gas turbine 30, for example, via an inlet of an air compressor 31 provided to the gas turbine 30 to compress air before combustion. Air compressed by the air compressor 31 is supplied to a combustion chamber 32 and is mixed with fuel, thereby undergoing combustion and driving a turbine 33 and a power generator 35.

The turbine 33, the air compressor 31 and the power generator 35 may all be connected to a single shaft, and electric power generated by the power generator 35 may be used to drive various devices provided in the marine structure or used as a power source. For example, the gas turbine 30 may be disposed to generate electric power or to generate motive power. Natural gas regasified in the ambient LNG vaporizer 10 may be used as fuel for the gas turbine 30.

When moist air containing the minute water particles is compressed in the air compressor 31 at a high pressure, the water particles contained in the moist air absorb heat generated during compression, noticeably reducing the temperature of air which will be used for combustion, that is, the temperature of combustion air. As the temperature of the combustion air in the air compressor 31 decreases during compression, compression work required in the air compressor 31 decreases. Since the compression work required in the air compressor 31 is performed by receiving power from the turbine 33, there are effects of enhancing output of the gas turbine 30 while reducing fuel consumption.

FIG. 1C is a schematic view illustrating the apparatus and a method 8 for increasing efficiency of a gas turbine according to another embodiment. For convenience, like numerals denote like elements to those of the embodiment describe above.

As shown in FIG. 1C, the LNG is gasified by the ambient LNG vaporizer 10 as needed, and is then supplied to consumers or supplied for use as fuel for various devices mounted on the marine structure, or for any other suitable purpose.

The ambient LNG vaporizer 10 regasifies the LNG via heat exchange with air. During heat exchange between the LNG and air in the ambient LNG vaporizer 10, the LNG is regasified into natural gas (NG) while air is cooled by heat transfer to the LNG. Here, since air contains vaporized water molecules, the heat exchange between air and the LNG condenses the vapor into condensed water.

The condensed water generated in the ambient LNG vaporizer 10 during LNG regasification is collected in a condensed-water storage tank 11 located below the ambient LNG vaporizer 10. Condensed water collected in the condensed-water storage tank 11 is supplied by a condensed-water pump 12 to a condensed-water nozzle 14 that is disposed inside a moist-air mixing chamber 20 to act as a condensed-water mixing mechanism. The amount of condensed water supplied from the condensed-water storage tank 11 to the condensed-water nozzle 14 may be adjusted by a condensed-water adjusting valve 13.

Cold air cooled by the heat exchange with the LNG in the ambient LNG vaporizer 10 is supplied to the moist-air mixing chamber 20 via a cold air supply pipe. The amount of air supplied to the moist-air mixing chamber 20 may be adjusted by an air adjusting damper 15 installed in the cold air supply pipe.

In the moist-air mixing chamber 20, condensed water is sprayed in the form of minute particles by the condensed-water nozzle 14 and is mixed with low temperature air cooled by the ambient LNG vaporizer 10, thereby forming moist air. Moist air obtained by spraying the minute water particles is supplied to a gas turbine 30 and is used for combustion.

As the amount of condensed water supplied to the moist-air mixing chamber 20 is adjusted by the condensed-water adjusting valve 13 while the amount of low-temperature air is adjusted by the air adjusting damper 15, it is possible to adjust the temperature and humidity of air supplied to the gas turbine 30 via the moist-air mixing chamber 20. Further, when the temperature and humidity of air are varied depending on external temperature, the temperature and humidity of air supplied to the gas turbine 30 can be stably maintained by adjusting the amount of condensed water and the amount of low-temperature air.

Moist air made by mixing air with the minute water particles in the moist-air mixing chamber 20 is supplied to the gas turbine 30, i.e., an inlet of an air compressor 31 provided in the gas turbine 30 to compress air before combustion. Air compressed by the air compressor 31 is supplied to a combustion chamber 32 and is mixed with fuel, thereby undergoing combustion and driving a turbine 33 and a power generator 35.

The turbine 33, the air compressor 31 and the power generator 35 may all be connected to one shaft, and electric power generated by the power generator 35 may be used in driving various devices provided in the marine structure or may be used as a power source. That is, the gas turbine 30 is installed to generate electric power or to generate motive power. Natural gas regasified in the ambient LNG vaporizer 10 may be used as fuel for the gas turbine 30.

When moist air containing the minute water particles is compressed in the air compressor 31 to a high pressure, the water particles contained in the moist air absorb heat generated during compression, noticeably reducing the temperature of combustion air. As the temperature of the combustion air in the air compressor 31 decreases during compressing, compression work required in the air compressor 31 decreases. Since the compression work required in the air compressor 31 is performed by receiving power from the turbine 33, there are effects of enhancing output of the gas turbine 30 while reducing fuel consumption.

As apparent from the above description, according to the embodiments of the present invention, the temperature of air supplied to a gas turbine can be lowered by the low-temperature air and the condensed water generated in the ambient LNG vaporizer, thereby noticeably enhancing efficiency of the gas turbine. Further, the condensed water generated in the ambient LNG vaporizer can be utilized instead of being disused, and the temperature of air supplied to the gas turbine can be stably and constantly maintained regardless of the external atmospheric temperature to thereby maintain a constant gas turbine output.

Further, a gas turbine operated under a method according to embodiments of the present invention with similar consumption requirements as a conventional gas turbine, has an output higher than conventional gas turbine, thereby reducing fuel consumption and supplying requisite power to the marine structure.

Although the method for increasing efficiency of a gas turbine using a cold source or cold heat from LNG recovered through an ambient vaporizer and a marine structure having the gas turbine have been described with reference to the accompanying drawings, embodiments of the present invention are not limited to the disclosed embodiments and drawings. It should be understood that various modifications and changes can be made by those skilled in the art without departing from the spirit and scope of the present invention as defined by the accompanying claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A marine structure comprising:
an ambient liquefied natural gas (LNG) vaporizer configured to regasify LNG in a cryogenic state via heat exchange with air;
a gas turbine configured to generate electric power or driving power;
a moist-air mixing chamber disposed upstream of the gas turbine;
a condensed-water nozzle to spray condensed water, condensed from air during the heat exchange in the ambient LNG vaporizer, into the moist-air mixing chamber; and
a cold air supply pipe to supply air, cooled by the heat exchange in the ambient LNG vaporizer, to the gas turbine via the moist-air mixing chamber.

2. A marine structure comprising:
an ambient LNG vaporizer configured to regasify LNG in a cryogenic state via heat exchange with air;
a gas turbine configured to generate electric power or driving power; and
a condensed-water mixing mechanism configured to cool air for combustion by mixing condensed water, condensed from air during the heat exchange in the ambient LNG vaporizer, with the air for combustion to be supplied to the gas turbine.

3. The marine structure according to claim 2, wherein the condensed-water mixing mechanism includes a nozzle to spray the condensed water in a form of minute water particles into the air for combustion to be supplied to the gas turbine.

4. The marine structure according to claim 2, further comprising:
a moist-air mixing chamber including the condensed-water mixing mechanism therein and disposed toward an upstream side of the gas turbine and configured to mix the air for combustion with the condensed water condensed in the ambient LNG vaporizer.

5. The marine structure according to claim 3, further comprising:
a cold air supply pipe configured to supply cold air as the air for combustion to the gas turbine, the cold air being generated by cooling the air using a cold source from the LNG via the heat exchange in the ambient LNG vaporizer.

6. The marine structure according to claim 5, further comprising:
a moist-air mixing chamber including the condensed-water mixing mechanism therein and disposed toward an upstream side of the gas turbine and configured to mix the cold air cooled in the ambient LNG vaporizer with the condensed water condensed in the ambient LNG vaporizer.

7. The marine structure according to claim 3, further comprising:
a condensed-water storage tank configured to store the condensed water condensed in the ambient LNG vaporizer, and
a condensed-water pump configured to transfer the condensed water stored in the condensed-water storage tank to the nozzle.

8. The marine structure according to claim 7, further comprising:
an adjusting valve configured to adjust an amount of condensed water to be transferred.

9. The marine structure according to claim 5, wherein the cold air supply pipe comprises an air adjusting damper configured to adjust an amount of air for combustion supplied to the gas turbine.

10. The marine structure according to claim 2, wherein the LNG gasified in the ambient LNG vaporizer is supplied as fuel to the gas turbine.

11. The marine structure according to claim 2, wherein the marine structure is a marine floating structure having LNG regasification equipment selected from at least one of an LNG RV (regasification vessel), an LNG FSRU (floating storage and regasification unit) and an LNG FPSO (floating, production, storage and off-loading).

12. A marine structure comprising:
an ambient LNG vaporizer configured to regasify LNG in a cryogenic state via heat exchange with air;
a gas turbine for generating electric power or driving power; and
a cold air supply pipe to supply air, cooled by a cold source from the LNG via the heat exchange in the ambient LNG vaporizer, to the gas turbine.

13. The marine structure according to claim 12, further comprising:
a condensed-water mixing mechanism to cool air for combustion by mixing condensed water, generated from air during the heat exchange in the ambient LNG vaporizer, with the air for combustion to be supplied to the gas turbine.

14. A method for increasing efficiency of a gas turbine in a marine structure having an ambient LNG vaporizer for regasifying LNG in a cryogenic state via heat exchange with air and a gas turbine for generating electric power or driving power, the method comprising:
cooling air for combustion by mixing condensed water, generated from air during the heat exchange in the ambient LNG vaporizer, with the air for combustion to be supplied to the gas turbine.

15. The method according to claim 14, further comprising:
exchanging heat between the LNG and the air in the ambient LNG vaporizer to regasify the LNG while cooling the air to a low temperature;
mixing the condensed water, generated from the air in the heat exchanging, with the air for combustion; and
supplying the air for combustion mixed with the condensed water to the gas turbine.

16. The method according to claim 14, further comprising:
exchanging heat between the LNG and the air in the ambient LNG vaporizer to regasify the LNG while cooling the air to a low temperature;
mixing the air cooled to the low temperature via the heat exchange with the condensed water generated from the air in the heat exchanging to generate the air for combustion; and
supplying the air for combustion containing the condensed water to the gas turbine.

17. An apparatus to increase efficiency of a gas turbine, the apparatus comprising:
an ambient liquefied natural gas (LNG) vaporizer configured to regasify LNG in a cryogenic state via heat exchange with air;
a moist-air mixing chamber disposed upstream of the gas turbine;
a condensed-water nozzle to spray condensed water, condensed from air during the heat exchange in the ambient LNG vaporizer, into the moist-air mixing chamber; and
a cold air supply pipe to supply air, cooled by the heat exchange in the ambient LNG vaporizer, to the gas turbine via the moist-air mixing chamber.

18. An apparatus to increase efficiency of a gas turbine, the apparatus comprising:
an ambient liquefied natural gas (LNG) vaporizer configured to regasify LNG in a cryogenic state via heat exchange with air; and
a condensed-water mixing mechanism configured to cool air for combustion by mixing condensed water, condensed from air during the heat exchange in the ambient LNG vaporizer, with the air for combustion to be supplied to the gas turbine.

19. The apparatus according to claim 18 wherein the condensed-water mixing mechanism includes a nozzle to spray the condensed water in a form of minute water particles into the air for combustion to be supplied to the gas turbine.

20. The apparatus according to claim 18, further comprising:
means for supplying air in fluid communication with the turbine including an air adjusting damper configured to adjust an amount of air for combustion supplied to the gas turbine.
